(19) United States
(12) Patent Application Publication
(10) Pub. No.: US 2026/0305632 A1
(43) Pub. Date: Oct. 8, 2026

(54) APPARATUS AND METHOD FOR PRESERVING BEVERAGES WITH REMOTE-CONTROLLED SYSTEM MONITORING AND DATA EVALUATION WITH FEEDBACK

(71) Applicant: LANXESS Deutschland GmbH, Köln (DE)

(72) Inventors: Jonas BURGHOLZ, Köln (DE); Erasmus VOGL, Bergisch Gladbach (DE)

(21) Appl. No.: 19/476,136

(22) PCT Filed: Mar. 21, 2024
(86) PCT No.: PCT/EP2024/057573

§ 371 Date: Oct. 16, 2025

(30) Foreign Application Priority Data
Apr. 27, 2023 (EP) 23170349.7

(51) Int. Cl. A23B 70/10; A23B 2/00; A23B 2/758; G01F 1/00

(52) U.S. Cl. CPC A23B 70/10; A23B 2/001; A23B 2/758; G01F 1/00

(57) ABSTRACT

An apparatus for preserving beverages, has a measuring device which is configured for determining a flow rate of a liquid flowing through a beverage line a pump device which conveys a preserving agent, in particular dialkyl dicarbonates, into the beverage line, and at least two further measuring devices, which determine at least two further characteristic measured values for the operation of the apparatus, wherein the apparatus has a control device for controlling the pump device wherein the apparatus has a storage device which enables at least the further characteristic measured values to be stored repeatedly and the control device is configured for controlling the pump device as a function of at least one of the stored measured values.

### BACKGROUND OF THE INVENTION

The invention relates to an apparatus and a method for monitoring a system for the preservation of beverages and the use of the apparatus for this purpose.

Preservatives such as dialkyl dicarbonates, sulphur dioxide, natamycin, benzoates or sorbates are used in the beverage industry for the cold sterilization of non-alcoholic carbonated or still fruit juice beverages, fruit juices, wines, non-alcoholic wines, ciders, iced teas and other beverages. Dialkyl dicarbonates, such as dimethyl dicarbonate or diethyl dicarbonate in particular, are a special cold sterilization agent with a number of advantages. The outstanding advantage here is the fact that taste and color are not affected, in contrast to hot filling. The advantage over persistent preservatives, such as sodium benzoate or benzoic acid or potassium sorbate or sorbic acid, is also the absence of any taste impairment and the disappearance of the effect. Due to the decomposition of dialkyl dicarbonates into harmless components, no preservative agent is consumed by the actual consumer.

Compared to cold aseptic filling, the significantly lower investment costs in plant technology are a well-known advantage of using dialkyl dicarbonates.

In the state of the art, diaphragm dosing pumps installed in the beverage line are used to add dialkyl dicarbonates, for example, which enable dialkyl dicarbonates to be introduced into the ongoing beverage flow. Otherwise, uniform and reliable distribution in the beverage cannot be guaranteed. One advantage of diaphragm pumps is that their pump chamber is completely sealed.

However, other types of pumps can also be used. Apparatuses with diaphragm pumps usually consist of a magnetically or electrically driven diaphragm pump, storage vessels, an apparatus attached to the beverage line for atomizing the dialkyl dicarbonate, a flow meter attached to the beverage line and an electronic control unit. Dosing pumps of this type are usually permanently installed in the beverage line.

The dosing pumps are advantageously suitable for several different performance parameters, in particular for small and very small quantities. In addition, these dosing pumps should have a high dosing accuracy, a high atomization pressure and a wide control range.

The mode of operation of these devices is based on the on-line measurement of the beverage flow rate in the beverage pipe and the quantity of dialkyl dicarbonate to be dosed calculated in parallel. Dialkyl dicarbonates are thus proportionally dosed into the beverage tube in the required quantity. Examples of these pumps are the VelcorinDT devices from Lanxess.

The present invention is based on the object of simplifying the operation of such apparatuses.

### SUMMARY OF THE INVENTION

An apparatus according to the invention for preserving beverages has a measuring device which is suitable and intended for determining a flow rate of a liquid flowing through a beverage line, and a pump device which conveys a preserving agent, in particular dialkyl dicarbonates, into the beverage line, and at least two further measuring devices which determine at least two further measured values characteristic of the operation of the apparatus, wherein the apparatus having a control device for controlling the pump device.

According to the invention, the apparatus has a storage device which enables repeated storage of at least the further characteristic measured values and the control device is suitable and intended for controlling the pump device as a function of at least one of the stored measured values.

In addition or alternatively, the apparatus preferably has an evaluation device which evaluates the data recorded by the measuring devices. This evaluation can be carried out using a model, in particular a simulation model and in particular using a simulation dosage model (hereinafter also referred to as dosage model for short).

In a preferred method, the evaluation device is an external evaluation device, in particular a cloud-based and/or an external server. An external server is in particular an external server, in particular a backend server, in relation to the (ego) pump device.

The external server is, for example, a backend of a manufacturer of the pump device according to the invention or of a service provider, which is set up to evaluate environmental data and/or data derived therefrom (in particular in each case in relation to filling situations in relation to a plurality of (ego) pump devices) and/or to manage and/or store (determined) notification variable(s). The functions of the backend or the external server can be carried out on (external) server farms. The (external) server can be a distributed system. The external server and/or the backend can be cloud-based.

In a further preferred method, control and/or regulation and/or monitoring of the pump device or the apparatus is performed as a function of a machine learning dosage model, in particular a trainable dosage model, which comprises a set of parameters, in particular trainable parameters, which are set to values that have been learned as a result of a training process, wherein the training process having been performed on the basis of a set of training data.

Preferably, the training data comprise at least one of a flow rate of the beverage present in relation to the pump device and/or the apparatus as a whole in relation to other variables characteristic of the dosing process, such as in particular a pressure of the preserving agent, a flow rate of the preserving agent and/or a temperature of the preserving agent.

Preferably, the training data comprise as a classification feature the information whether the condition corresponds to a (fault-free) normal operation and/or whether a malfunction is present and/or whether a (progressive) ageing condition of the pump device and/or the apparatus as a whole is present.

Preferably, the dosage model is suitable and intended to detect (in the training data) deviations and/or anomalies and/or patterns which recognize a fault condition and/or malfunctions and/or (advanced) aging of elements of the pump device and/or the apparatus as a whole and/or a need for maintenance of the pump device and/or the apparatus as a whole.

Preferably, the dosage model outputs a characteristic probability value (as output variable) depending on the input variables.

In a preferred embodiment, the storage device allows the measured value to be stored with a time assignment. Preferably, the storage device also allows a measured value characteristic of the flow rate and/or one or more measured values recorded by the above-mentioned measuring device to be stored.

In a preferred embodiment, the apparatus has at least one receiving container for at least temporarily holding the preserving agent. Preferably, this receiving container is arranged upstream of or before the pump device in a flow direction of the preserving agent. Particularly preferably, the pump device can remove the preserving agent from this receiving container.

Preferably, the apparatus has a venting device for venting the pump device. This venting device preferably has a measuring device or sensor device which determines at least one measured value which is characteristic of a venting state of the pump device.

In a further advantageous embodiment, the apparatus has a further receiving device for receiving the preserving agent. It is possible that the preserving agent is first conveyed from one of the two receiving devices into the second receiving device. Particularly preferred, the second receiving device(s) is/are a receiving container and, in particular, a buffer container.

In a further advantageous embodiment, the apparatus has a comparison device which is suitable and intended for comparing the characteristic measured value with a reference value. For example, a difference between the reference value and the measured value can be determined. A quotient can also be formed between the characteristic measured value and the reference value. This reference value or target value can be a predefined target value and/or a measured value that is also stored in the storage device.

It is also possible to check whether a deviation between the measured value and the target value and/or reference value is within predetermined limits. If this is not the case, an alarm can be issued.

In a further preferred embodiment, the apparatus has an alarm output device which is suitable and intended to output an alarm when an error condition occurs. Preferably, the above-mentioned storage device is suitable and intended for storing data characteristic of this alarm. For example, a time of the issued alarm and the said measured value and, if necessary, further measured values can be stored.

The storage device can be an internal storage device, for example arranged on or in the pump device or its controller, but it can also be a cloud or an Internet storage.

In another preferred embodiment, the pump device can also be controlled as a function of a flow rate determined by the measuring device. It is possible that this flow rate is determined (in particular permanently) and the pump device is controlled as a function of this.

In a preferred embodiment, the apparatus has a model generation unit which is suitable and intended for generating a model for operating the apparatus on the basis of a plurality of measured values. This model is also referred to below as a dosage model. On the basis of this model, it is possible to simulate the apparatus and/or its operation.

It is possible for measured values to be determined and preferably sent to a manufacturer. This manufacturer preferably creates a simulation environment on the basis of said measured values or physical parameters. In this simulation environment, a test system is put into operation, which is in particular identical in construction to the apparatus. Operating parameters are determined on the basis of this operation of the test system and these are in turn output to the individual (real) apparatuses so that they can now work with parameters recorded under realistic ambient conditions or operating recipes determined in this way.

Preferably, an operating recipe determination device is provided, which determines an operating recipe for operating the apparatus on the basis of the parameters and/or measured values. This operating recipe determination device can also make use of already known system-specific values. Preferably, the test apparatus also has further sensor devices that determine parameters characteristic for the operation of the test apparatus, such as temperatures or pressures.

In a further preferred embodiment, the apparatus has artificial intelligence for controlling the apparatus.

In a preferred embodiment, the apparatus has an injection device which is suitable and intended for injecting a preserving agent conveyed by the pump device into the beverage line. In a preferred embodiment, the injection device is arranged such that it enables injection of the preserving agent in a direction which forms an angle of at least 10°, preferably of at least 20°, preferably of at least 30° and preferably of at least 40° with a flow direction of the beverage.

In a further preferred embodiment, the injection device can be heated. In a further preferred embodiment, the injection device can be heated by an electrically operated heating device. Preferably, a measuring device is provided which determines a temperature of at least one region of the injection device.

In a further preferred embodiment, the injection device is designed in such a way that turbulence of the preserving agent is achieved in an injection area.

In a further preferred embodiment, a nozzle cross-section of the injection device is variable.

Preferably, the injection device, which injects the preservative into the beverage, is arranged in a curved area of the beverage line or injects the preserving agent in a curved area of the beverage line. In this way, the turbulence of the beverage occurring in this curved area can be used to inject the preserving agent.

In a further advantageous embodiment, at least one measured value is selected from a group of measured values which are characteristic for a pressure of the preserving agent, for a temperature of the preserving agent, for an outside temperature, for a flow rate of the preserving agent, for a fill level of the preserving agent (within a receiving container), for the presence of a gas in the pump device, for a pressure under which the preserving agent is conveyed into the beverage line, for a temperature of the beverage, for a temperature of an injection device by which the preserving agent is injected into the beverage line and the like.

The apparatus particularly preferably has a time measuring device and/or a timer. In this way, it is possible to store recorded measured values together with a time value. Particularly preferably, the apparatus has a timer which controls and/or triggers the storage of the measured values.

The invention is based on the idea that corresponding values are recorded with a plurality of measuring devices and these values are preferably stored continuously and/or cyclically. In this case, online monitoring of the apparatus can preferably be dispensed with, but data can be derived from the stored values at the same time, if necessary also later.

Preferably, a measuring device is also provided which detects a position of the pump device and/or an element of the pump device and/or a value characteristic of the operation of the pump device, for example a position of the diaphragms or a valve position of valves of the pump device. This detection is particularly preferably time-dependent. This can be done, for example, via a position sensor, but other data can also be evaluated, such as a torque or a power of a drive device of the pump device, or corresponding currents and/or voltages.

In a further preferred embodiment, the apparatus has at least three further measuring devices, preferably at least four further measuring devices and particularly preferably at least five further measuring devices, each of which preferably determines at least one measured value characteristic of the operation of the apparatus.

In a further preferred embodiment, the control device is suitable and intended for controlling the apparatus by remote data transmission means. For example, it is possible for the apparatus and in particular the pump device to be controlled from a location that is different from the operating location of the apparatus, for example a location outside an operating site of the apparatus. The remote data transmission means may in particular be the Internet, by which the control takes place.

The invention is based on the idea that corresponding values are recorded with a plurality of measuring devices and these values are preferably stored continuously and/or cyclically. In this case, online monitoring of the apparatus can preferably be dispensed with, but data can be derived from the stored values at the same time, or even later if necessary. An operating model or dosage model for operating the apparatus can also be created on the basis of these stored values.

In a further preferred embodiment, the apparatus is suitable and intended for detecting and/or recording alarm and/or error states, in particular with time allocation. In particular, direct recording is possible.

Preferably, other measured values are also assigned to these alarm or error states. For example, further measured values can also be assigned to a specific alarm or error state.

For example, if an error is detected at a time t1, further measured values that occurred at this time can be recorded, such as a temperature of the preserving agent or the beverage.

In a further advantageous embodiment, the apparatus and in particular the pump device is suitable and intended for recording and preferably storing a plurality of machine and/or consumption data.

On the basis of this plurality of data, it is preferably possible to control the apparatus at least temporarily without continuous monitoring of the apparatus for this purpose.

Preferably, the apparatus also has a detection device for detecting tampering, improper maintenance, replacement of original components with other components and the like. For example, it is possible to detect when certain components of the apparatus have been replaced by substitute components that do not meet the manufacturer's quality requirements.

For example, these components could have a means of identification such as an RFID tag that can be recognized by the apparatus. More precisely, the manufacturer's original components may have such a means of recognition. If a component is inserted into the apparatus that does not have such an (individual) means of identification, the apparatus can recognize this.

In a further preferred embodiment, the apparatus also has at least one detection device which is suitable and intended for detecting proper installation of components of the apparatus.

In a further advantageous embodiment, the apparatus has an assignment device which is suitable and intended for assigning characteristic business data to the apparatus for this apparatus. This may be data which is characteristic of operating hours of this apparatus, for example, but also data which is characteristic of payment processes of the apparatus, such as leasing rates or the like.

It is preferably possible to take into account economic data such as violations of economic framework conditions. Preferably, the apparatus can issue warnings.

Preferably, the control device can also take this data into account and initiate measures such as announcing or implementing a stop of the apparatus.

In a further advantageous embodiment, the apparatus has at least one detection device for detecting environmental data. Preferably, this environmental data is selected from a group of data comprising a temperature, an air pressure, a humidity and the like. Accordingly, these detection devices are selected from a group of detection devices which includes pressure measuring devices, (air) humidity measuring devices, temperature measuring devices and the like.

By taking this data into account, improved control of the apparatus is possible as such data also influences the operation of the apparatus. In addition, taking this data into account can also improve the creation of a system model for operating the apparatus.

In a further preferred embodiment, the apparatus has a detection device for detecting the operating behavior of an operator. For example, it is possible to record and/or store when an operator of the apparatus has taken which operating action.

In this way, it is possible to record whether the apparatus is being or has been operated correctly. For example, the type and times of an operation can be recorded.

Particularly preferably a specific machine operation is assigned to a specific operator, for example by identifying the operator in each case.

In this way, it is possible to detect individual incorrect operation of the apparatus. The respective operator can be made aware of such operating errors.

The above-mentioned data or measured values can be, for example, a consumption of the preserving agent per unit of time, a pressure in the pressure line in which the preserving agent is conveyed from the pump device to the beverage line, or the like.

For example, it is possible that a position of a mechanical element of the pump device, a suction-side pressure of the preserving agent, a pressure-side pressure of the preserving agent, a temperature of the preserving agent, a fill level of a buffer vessel in which the preserving agent is located, a flow rate of the beverage and possibly further data are stored at a specific time. This data can, for example, be recorded as n-tuples of related data.

In a preferred embodiment, the apparatus has an interface, and in particular a data communication interface, which enables data communication with a further control device and/or with a further storage device.

For example, a touch panel function with a storage size that allows machine data to be stored at intervals of less than 20 seconds, preferably less than 10 seconds, preferably less than 5 seconds and particularly preferably less than 2 seconds, can be provided.

Preferably, an interface, for example a USB interface (particularly preferably outside an equipment cabinet of the apparatus) is provided, which also enables (manual) access to the stored data for persons who are not electronically instructed.

Preferably, the apparatus has a control device that enables the apparatus to be controlled from a control center of the operator.

In a further preferred embodiment, the apparatus and in particular the pump device has a storage device which is suitable and intended to record all important machine and consumption data and preferably to store these in a transmissible manner. Furthermore, the storage device is preferably also suitable and intended to record alarm states and preferably all alarm states and preferably to record them in a transmissible manner.

In a further preferred embodiment, the pump device is a dosing pump. The pump device is particularly preferably a diaphragm pump, wherein although the use of a piston pump is also possible.

If, for example, a certain measured value, such as a measured pressure value on the pressure side, is outside a specified tolerance window, this can be recorded and the corresponding time can also be recorded at the same time. In this way, a subsequent error analysis is possible and predictions can be made that indicate a specific cause of the error.

In a preferred embodiment, a processor device is provided which outputs at least one value characteristic of a forecast on the basis of previously recorded and/or stored values. For example, it can be determined from a plurality of recorded data that a certain pressure value of the pump device is continuously changing. This can be an indication of an imminent failure of a specific machine part and the user can be informed of this.

In this way, it is possible for a future failure of a part of the apparatus to be detected (based on the data or measured values). Preferably, artificial intelligence (AI) can be used for this purpose.

The above-mentioned evaluation device is in particular suitable and intended for retrieving a predetermined plurality of measured values (preferably in particular those recorded by the measuring devices), in particular those stored on a non-volatile storage device, and for processing the retrieved plurality of measured values or data derived therefrom using a, in particular trainable, simulation-dosage model of machine learning, which comprises a set of, in particular trainable, parameters that are set to values that have been learned as a result of a training process.

In a preferred embodiment, the storage device allows repeated storage of data with time intervals of less than 5 seconds, preferably less than 2 seconds, preferably less than 1 second, preferably less than 500 ms, preferably less than 200 ms and particularly preferably less than 100 ms. In this way, rapidly changing states can also be detected, such as those that occur during a pump cycle.

In a preferred embodiment, the apparatus has a transmission device that is suitable and intended for transmitting the data recorded by the memory device to a further memory device.

For example, an IoT (Internet of Things) gateway can be provided, which is preferably integrated into the pump device. This can be designed as an electronic controller and/or circuit card, for example. It is possible for this IoT to use a SIM card or other telecommunications connections to allow the pump device data recorded by the memory device to be transmitted to a further memory device or a higher-level process controller at predefined intervals, for example once a day.

This transmission can take place using telephone connections or extra available IoT bandwidths, for example. The further memory device can also be a cloud, for example, or a central storage of the machine manufacturer. This enables the machine manufacturer to also monitor apparatuses located at other sites and, if necessary, issue statements that are required for operation.

For example, by evaluating this data, a customer can be informed that certain components need to be replaced, such as valves or the diaphragms of a diaphragm pump or similar.

It is possible that the transmission of this data is integrated into a software of the pump device and takes place automatically. In addition, it would also be possible for the relevant data to be requested from a cloud storage by a query device or to be triggered there itself.

Preferably, the above-mentioned storage device is suitable and intended for storing a plurality of different values characteristic of the apparatus and/or its operation and/or the preserving agent. Preferably, this storage takes place together with a time stamp or with a time.

Preferably, the apparatus has a data reduction or data compression device which reduces the amount of data stored. For example, it would be possible for measured values that do not change over a specified period of time, such as temperatures, to only store a temperature and a relevant period of time over which this temperature was constant.

Unforeseen machine conditions can be detected from the recorded data, in particular after transmission to the further storage device such as a cloud, and in this way a proactive service action can be initiated, for example. For example, an alarm table can be evaluated (preferably continuously or cyclically). This can be done, for example, with the help of defined alarm accumulation threshold values.

In a particularly preferred embodiment, the storage device is suitable and intended for storing data characteristic of a fault condition of the apparatus. For example, a time of an occurring fault, measured values of this fault and the like can be recorded and/or stored.

If, for example, a certain measured value, such as a measured pressure value on the pressure side, is outside a specified tolerance window, this can be recorded and the corresponding time can also be recorded at the same time. In this way, subsequent fault analysis is possible and forecasts can be made that indicate a specific cause of the fault.

For example, an alarm is always triggered if the dosage of dimethyl dicarbonate is too low (under-dosage alarm). This alarm can occur, for example, if incorrectly stored dimethyl dicarbonate has been used, which is beginning to decompose, resulting in decomposition in the dosing pump or pump device in carbon dioxide gas and the pump device is then often only incompletely deaerated and the dosage is lower in this state. The insufficient dosage can be determined, for example, by a flow measuring device, but also with suction-side pressure measuring devices.

If an accumulation of under-dosage alarms is detected during the automatic or manual evaluation of the data on a storage device (e.g. a cloud storage device), the beverage bottling plant (user) can be contacted proactively to draw attention to this faulty situation. As a countermeasure, the dimethyldicarbonate can be replaced, for example.

Deviations can also be used from the recorded machine data, in particular the electrically monitored dosage, to deduce a machine malfunction.

The electronic readjustment can also be used to deduce a change in the dosing pump, for example wear of individual pump parts such as valves or the like, from the process, in particular from the changes.

In a further advantageous embodiment, the apparatus has an operating device which enables user input, wherein this operating device preferably has a display device for displaying data and/or measured values, wherein these measured values are preferably characteristic of the apparatus and/or the operation of the apparatus.

For example, a touch panel function can be provided, which preferably has a storage device or storage size that enables machine or operating data to be stored at intervals. These intervals are particularly preferably less than 20 seconds, preferably less than 10 seconds, preferably less than 5 seconds and preferably less than 2 seconds.

However, it would also be possible to record data or a small amount of data at even shorter intervals. For example, suction-side and pressure-side pressure values of the pump device could be recorded over a short period of time and at short intervals, for example to monitor one or more pumping cycles of the pump device.

For example, it is possible to check how the controlling the pump affects the corresponding pressure values. This data can be transmitted repeatedly, for example once a day or once a week. In this way, it is possible to determine how the delivery behavior of the pump changes over time depending on its controlling. In this way, for example, the user can be informed whether and, if so, which components of the pump need to be replaced in the near future.

In a further advantageous embodiment, the apparatus has a further communication interface which enables data to be transmitted to an external storage device or an external device in relation to the apparatus. This interface can thus be an automated interface which, for example, transmits a plurality of data to the higher-level storage device once a day. It is also possible for the data to be evaluated and any deviations between consumption and sales figures to be determined. In the invention, an automated plausibility check can be carried out on the contractually agreed conditions that only the Velcorin cold sterilization agent provided by the machine manufacturer is used.

If a possible deviation is detected, a corresponding message could be issued, for example in the form of a pop-up window on the TPC of the dosing devices, indicating incorrect operation or possible misconduct, with the request to contact the responsible sales personnel of the Velcorin distributor. Furthermore, automated information (SMS, e-mail, . . . ) can also be sent to the responsible Velcorin sales partners with information about an anomaly on the respective dosing device.

In a further preferred embodiment, the apparatus has a position detection device which is suitable and intended for detecting a position of the apparatus and/or pump device. For example, the apparatus may have a GPS module. It is possible and preferred that this position detection device is permanently integrated into the apparatus. Preferably, this position detection device is integrated into the apparatus in such a way that it is not possible to remove this position detection device without interfering with the apparatus and preferably also not without damaging the apparatus. In this way, the theft protection of the apparatus can be increased.

In a further advantageous embodiment, the control device is suitable and intended to control the apparatus as a function of a detected position of the apparatus. For example, it is possible for the control device to switch off the pump device if it is detected that the apparatus or the pump device is outside a predetermined geometric range.

In a further preferred embodiment, the apparatus has a power source for supplying the position detection device. Thus, the position detection device can preferably also be operated when the pump device is disconnected from a power supply.

In this embodiment, the invention preferably provides that the location of the apparatus or the dosing devices is determined at least temporarily and preferably continuously by an online linked technology with GPS module (e.g. IoT gateway, SIM card, . . . ) and transferred to the stored data storage (this can be a cloud or another storage location).

In the best case scenario, this can in turn lead to a corresponding alarm being issued as soon as a change of location of a dosing device is detected, e.g. sent to the responsible sales employees, so that this case can be investigated and thus ensure that contractually agreed installation locations are changed without consent or, for example, that dosing devices owned by customers of the machine manufacturer are sold and there is a potential risk that a new customer will not use the respective dosing device as intended in accordance with the specifications in the manual with Velcorin. Theft protection can also be improved in this way.

Furthermore, the position detection device, for example GPS detection of the apparatus or the dosing devices, is preferably used for global management of the systems. A further option that is considered within the scope of the invention is so-called geo-fencing. This function can provide that an alarm and a remote-controlled shutdown/deactivation of the system is carried out when an apparatus or dosing device leaves a defined radius of the last stored GPS coordinates.

In a further preferred embodiment, the apparatus has a data transmission device which transmits recorded data to a storage device at predetermined and, in particular, adjustable intervals.

Preferably, the invention is designed so that an internal device of the apparatus, for example with an internal software of the apparatus, establishes a connection to the stored storage location of all recorded data (e.g. cloud server) at predetermined intervals, for example every 24 hours, preferably every 12 hours, preferably every 6 hours, preferably every 1 hour, and preferably verifies itself there. During verification, critical values such as the GPS signal, the power supply or interruptions and all further system parameters for internal and external control of the system can be queried.

If verification with the cloud server fails, the internal software can notify the operator of the system with a corresponding pop-up window on the TPC of the dosing device and a countdown to deactivation is displayed. This defined time window can give the operator of the system the opportunity to inform the respective authorized service partner before the software deactivates the system in order to prevent potential improper handling of the dosing devices or technical defects.

The purpose of automated monitoring and remote control is for the purpose of system safety, operational safety, prevention of compliance with contractual components and for the safety of service technicians who carry out regular maintenance, repairs and checks on the dosing devices.

Within the scope of the invention, it is thus possible for the dosing devices to be deactivated remotely via online access if certain defined threshold values (beverage temperature, Velcorin dosage, maintenance intervals, number of critical alarms in a defined time window, etc.) are repeatedly or continuously exceeded or deviated from.

One aim of the invention is remote-controlled access to the vital functions of the dosing devices to prevent accidents involving personal injury and damage to property that can be caused by improper operation of the dosing devices. A further aim is to prevent economic damage and recourse in connection with inadequately treated beverages containing Velcorin that could end up on the market.

Further, remote controlled deactivation can be used if Velcorin customers have not paid for goods already delivered and the payment deadline has been exceeded. If systems in the possession of the machine manufacturer are illegally sold or retained, the system can also be deactivated.

The determination of excessive amounts of data can also have an impact on remote intervention. Such information would also be subject to an automated plausibility check and could possibly be an indication of hacker and/or third-party access to a possible IoT gateway or the software in general.

The scope of the invention also provides for a gradation in the various notification and deactivation levels. Depending on the classification of the potential danger or the severity of a possible contractual violation and for the protection of intellectual property, a possible cascading of the deactivation can range from a simple notification via the notification of certain groups of people, for example via a threatened deactivation with a countdown, via an immediate deactivation of the system up to the destruction of the software on the circuit cards and the TPC.

Feedback on operating behavior is also within the scope of the invention. For example, voluntary training courses or even mandatory retraining courses can be offered if repeated incorrect operation of the devices becomes apparent from the data evaluation.

It is also in the scope of the invention to use not only data from a single dosing pump for circular feedback, but also evaluations from a larger number of devices (big data). For example, a global evaluation can result in actions in which regions more intensive service support for customers is required, and in which regions the service intensity could possibly be reduced.

This can be done, for example, by evaluating alarm frequencies. Alternatively, the service and maintenance offerings for customers could be improved globally. For example, spare parts could be stored locally for faster availability or local price reductions could be introduced for spare parts that are more important regionally.

Also within the scope of the invention are consumption predictions, for example from data during global events, in order to achieve better product availability.

The present invention is further directed to a method for preserving beverages. A measuring device determines at least temporarily and preferably continuously a flow rate of a liquid flowing through a beverage line, in particular a beverage, and a pump device delivers a preserving agent, in particular dialkyl dicarbonates, into the beverage line.

Furthermore, at least two further measuring devices determine at least two further characteristic measured values for the operation of the apparatus and a control device controls the pump device. Preferably, these are different measured values and, in particular, measured values which are characteristic of two different properties.

According to the invention, the apparatus has a storage device which repeatedly stores at least the further characteristic measured values and the control device controls the pump device as a function of at least one of the stored measured values and preferably as a function of both measured values and particularly preferably several of the stored measured values.

In a preferred method, no online monitoring of the apparatus is carried out at least temporarily.

Preferably, the control device controls the pump device at least temporarily also as a function of the measured flow rate.

In a further preferred method, a machine model or dosage model is generated for controlling the apparatus and/or the pump device, wherein at least some of the measured values recorded are preferably used to generate this dosage model.

Preferably, the dosage model is generated using artificial intelligence.

Preferably, measured values of several apparatuses and/or several pump devices of the type described above are used to generate the model.

In a further preferred method, alarm and/or error states of the apparatus and/or the pump device are recorded and, preferably, data and/or measured values characteristic of these alarm and error states are recorded. If, for example, a fault condition occurs at a time t1, further measured values that occurred at this time are recorded, for example a pressure p(t1).

An error state is, in particular, a state in which one or more recorded measured values are outside the specified tolerance windows. An alarm state is preferably a state in which a detected error is so serious that a user must be informed of this error state and, if necessary, must intervene in the operation of the apparatus.

Preferably, when such error states occur, the times and/or durations at which these error states occurred are also recorded. In addition, when error states occur, a plurality of measured values that occurred at this time are also preferably recorded and preferably also stored.

Preferably, all measured values are recorded and stored.

In a further preferred method, the apparatus is at least temporarily remote-controlled. For example, a control device can be provided which is not located at the location of the apparatus, but at a remote location. Preferably, remote control takes place via the Internet.

According to the invention, the apparatus has a storage device which stores the further characteristic measured value, in particular repeatedly. Preferably, this is a storage device which stores the measured value over a longer period of time (in contrast to a volatile storage, for example), in particular a period of time which is greater than 1 second, preferably greater than 10 seconds, preferably greater than 1 minute and preferably greater than 10 minutes and particularly preferably greater than 1 hour.

In a further method according to the invention, an evaluation device evaluates the above-mentioned measured value(s), in particular using artificial intelligence (AI). This configuration can be carried out as an alternative or cumulatively to the above-mentioned storage of data. Preferably, the evaluation is carried out using a model and in particular a simulation model and in particular a simulation-dosage model. This model can take into account dependencies between the individual measured values and a specific controlled variable, such as a pump output.

It is particularly preferable for the measured values to be stored with a time assignment, i.e. in particular together with a time value characteristic of the time of their occurrence.

Preferably, a plurality of measurement devices (and/or sensor devices) are used to record a plurality of measurement values characteristic of the operation and the storage device preferably stores these measurement values repeatedly and/or cyclically. For example, several measured values or a set of measured values can be recorded at many different points in time, for example more than 10, preferably more than 20, preferably more than 50 and preferably more than 100 and preferably more than 500 different points in time.

Preferably, an n-tuple of measured values is stored in this way. Storage is particularly preferred at intervals of less than 1 minute, preferably less than 30 seconds, preferably less than 20 seconds, preferably less than 10 seconds, preferably less than 5 seconds and preferably less than 2 seconds. In this way, very precise observation of the apparatus is possible, both over longer periods of time and over shorter periods of time and with greater accuracy.

Preferably, the interval at which measured values are recorded and stored can be changed. It is possible for the user to specify corresponding time intervals. However, it would also be possible for the apparatus to change the time intervals. For example, it would be possible for a time interval to be shortened if one or more measuring devices output atypical measured values.

Preferably, a plurality of stored measured values are transmitted to a storage device. For example, it is possible that a number of n data records, for example 1000, 2000 or 3000 data records, were recorded on a particular day, wherein the above-mentioned measured values were recorded at different times.

In a further preferred method, the apparatus is controlled and in particular readjusted on the basis of the measured values recorded. It is thus possible for the control and/or regulation to be carried out with reference to and/or taking into account the measured values recorded. In this way, the measuring device or devices can be integrated into a control loop for controlling the pump device.

This complete data set can be transferred to a further storage device such as a cloud, which can be done once a day, for example. This variety of data can in turn be used to derive operating data for the machine or, if necessary, to make forecasts. For example, this variety of data can be used to determine that a certain pressure value has continuously dropped. Countermeasures can be derived from this, such as replacing the preserving agent. It is preferably possible for this transmission of the plurality of data records to be wireless.

In a preferred method, data characteristic of error states of the apparatus are recorded and/or stored. For example, alarm states can occur if certain measuring devices fail. In addition, alarm states can occur or be recorded if it is determined that too little preserving agent is being added to the beverage. It would therefore be possible for corresponding alarm states to be stored at a certain point in time.

By also observing these error states, it is possible to determine, for example, that the frequency of a certain error state changes over time. This in turn can also be used to draw conclusions that are characteristic of the operation of the apparatus.

Particularly preferably, values are output directly to a user via a display device. These can be, for example, measured pressure values or the like or the output of alarms when certain error states occur.

Surprisingly, it was found within the scope of the invention that it is still possible to support the user with practically all the advantages of genuine online monitoring, using considerably simpler components and controls.

The electronic readjustment can also be used to derive a change in the pump device or dosing pump from the process and in particular from its changes.

A further advantage of the invention is that the regular transmission function of machine and consumption data from the dosing pump provides the beverage filling operation with an additional safety function in the event of any loss of consumption data. For example, it may happen that the software or hardware of the dosing pump is damaged due to an electronic defect or, for example, due to an overvoltage event in the production system and it is no longer possible to query the data locally on the dosing pump, even via the USB output.

Thanks to the continuous additional data storage, which is sent to the cloud storage via an IoT gateway, for example, it is still possible to record a history up to the time the damage occurred and to retrieve this data if required.

Furthermore, it was surprisingly found that the correlation of the outside temperature with the dosing correction factor allows a reliable diagnostic statement to be made about the condition of the dosing pump. It was found that for each dosing pump there is a fixed correlation of the dosage correction at a given temperature. If the dosage correction at the respective temperature changes significantly compared to the previously transmitted values, there is an increased probability that mechanical damage is imminent.

Furthermore, errors in operation can be detected, for example if changes of the preserving agent are not carried out in time and/or a standstill alarm is triggered. This data can then be used to derive and offer proactive training for operators, for example.

Furthermore, new parameters for monitoring correct production processes can be derived. For example, the additional monitoring of the beverage temperature and density makes it possible to check the Brix setting in addition to, in parallel with or instead of the analytical evaluation in the laboratory and to store it as a necessary criterion for release by a setting in the software.

Furthermore, the effectiveness of the CIP (cleaning in place) process can be monitored by measuring the temperature and its time curve in the flow meter. A temperature and time query can be used to classify whether the cleaning and disinfection process will be sufficient. Depending on the level of safety achieved, the predetermined quantity of dialkyl dicarbonate can then be automatically increased or reduced. Alternatively, the amount of dialkyl dicarbonate can be kept constant but the operator can be guided by a query on the dosing pump regarding the hygiene situation, in particular with the option of manual readjustment.

Dimethyldicarbonate is particularly preferred as dialkyldicarbonate, even more preferably dimethyldicarbonate with a purity >99.8% is used as dialkyldicarbonate. In a further embodiment of the invention, dimethyldicarbonate is used which has been stabilized by suitable processes.

Such processes, such as the use of a phosphorus compound from the series of phosphorus oxides, phosphorus-oxygen acids and derivatives thereof, are known, for example, from EP 2 013 160 B1. EP 2 016 041 B1 describes the use of at least one protonic acid from the series of inorganic acids and organic carboxylic acids and derivatives thereof, wherein the organic carboxylic acids are saturated and mono-or polyunsaturated aliphatic monocarboxylic acids and saturated and mono- or polyunsaturated aliphatic di- and polycarboxylic acids and their derivatives are hydroxamic acids, hydroxycarboxylic acids, aldehyde and keto acids, for stabilizing dialkyl dicarbonates against chemical and thermal degradation reactions, wherein the protonic acid or mixtures thereof being present in an amount of 0.01 to 100,000 ppm, preferably between 0.1 and 10,000 ppm based on dialkyl dicarbonates or mixtures thereof.

In a further embodiment of the invention, dimethyldicarbonate is used in a mixture with phosphorus compounds, such as preferably phosphates, even more preferably with trimethylphoshate or phosphoric acid. Preferably, the phosphorus compound is used in an amount between 0.01 ppm and 1000 ppm, preferably 0.1 ppm and 100 ppm based on the total amount of the mixture of dimethyl dicarbonate and phosphorus compounds.

In a further preferred method, at least one statistical predicted value (such as a predetermined dosage value) is determined by processing and/or evaluating the plurality of measured values or data derived therefrom and, if necessary, further additional method steps (in particular computer-implemented method steps). In particular, the dosage size refers to the preserving agent to be dosed into the beverage line.

Preferably, a plurality of measured values are used, in particular from different measuring devices. Preferably more than two, preferably more than three and particularly preferably more than four measuring devices are provided, the measured values of which are evaluated. These are preferably measured values that are characteristic of different state variables, such as flow rates, pressures, temperatures, pump outputs, etc.

Preferably, the measured values (recorded and/or stored) are time-resolved measured values, for example measured values that were recorded over a predetermined period of time. Preferably, a plurality of different measured values are recorded and/or stored over a predetermined period of time.

The evaluation device processes the retrieved (predetermined) plurality of measured values or data derived therefrom using a, in particular trainable, simulation-dosage model of machine learning, which comprises a set of, in particular trainable, parameters that are set to values that were learned as a result of a training process. Preferably, the at least one statistical forecast dosage is determined thereby and/or on the basis of this processing (preferably in a computer-implemented method step, in particular by the evaluation device).

In a preferred method, the training process of the dosage model uses training data which comprises historically recorded data, in particular for limit values and/or states, limit values for a repeated reaching of limit values and/or states, limit values for a temporal change and/or a speed of change of values characterizing the current state, statistical limit values and/or states of pump devices and/or dosage devices in general which are different from (but preferably identical in construction to) the pump device (and/or the apparatus). This offers the advantage that a large amount of training data can be generated in a short time and any malfunctions of the pump device and/or the apparatus as a whole can be detected.

Preferably, at least one variable relevant to the dosage and preferably a plurality of variables relevant to the dosage is determined by processing measured values using the simulation dosage model. This relevant variable can be, for example, a (preferably also time-dependent) pump output of the pump device.

Preferably, the at least one variable characteristic of the dosage and preferably the plurality of variables characteristic of the dosage is determined from the measured values or data derived therefrom using a processor device and/or data processing device (using the simulation dosage model), by applying at least one (computer-implemented) pattern recognition method and/or feature extraction method and/or feature reduction method. Pattern recognition is understood here in particular to mean recognition of a time-dependent progression of measured values or their development and/or change over time.

Preferably, the determination of the at least one dosage variable and/or preferably the processing of the (retrieved and in particular predetermined) plurality of measured values or data derived therefrom (using the simulation dosage model machine learning) is based on an (artificial) neural network and in particular on (computer-implemented) machine learning methods based on at least one, and in particular exactly one, (artificial) neural network. Preferably, the simulation-dosage model of machine learning is based on an (artificial) neural network.

Preferably, the neural network is designed as a deep neural network (DNN), in which the parameterizable processing chain has a plurality of processing layers, and/or a convolutional neural network (CNN) and/or a recurrent neural network (RNN).

Preferably, the data (to be processed), in particular the measured values (and/or data derived therefrom), are fed to the simulation dose model or the (artificial) neural network as input variables. Preferably, the simulation dosage model or the artificial neural network forms the input variables to output variables as a function of a parameterizable processing chain, wherein the dosage variables (such as a pump output) are preferably selected as the output variable.

Preferably, at least one manipulated variable for controlling and/or regulating the dosing process (of the pump device), preferably a variable characteristic of the pump device, is selected as the output variable.

Preferably, at least one manipulated variable for controlling and/or regulating the dosing process (of the pump device), preferably a variable characteristic of a pump output, is selected as the output variable in each case for each pump device.

Preferably, the simulation-dosage model of machine learning or the artificial neural network is trained using predefined training data, wherein the parameterizable processing chain is preferably parameterized by the training. Preferably, measured values recorded by the measuring device or the measuring devices of the apparatus (or data derived therefrom) are used as training data. This offers the advantage that the simulation dosage model or the artificial neural network can be specially adapted to the conditions of the specific dosage apparatus.

However, it is also conceivable that measured values recorded by a measuring device (at least) of another, preferably identical in construction, apparatus (preferably from the same manufacturer) are used as training data. This has the advantage that a plurality of measured values can be provided and used.

However, it is also conceivable that (exclusively or partially) synthetically generated measured values or data generated via data augmentation are used as training data. This offers the advantage that rarely occurring classes of operating states can be simulated and the machine learning model can be trained using this.

The training process can be carried out locally (at the apparatus) and/or centrally and/or independently of location and/or on an external server in relation to the dosage apparatus.

Preferably, a neural network trained in this way is used (in the framework and/or as a simulation dosage model). Preferably, the training is carried out by supervised learning. However, it would also be possible to train the simulation dosage model or the artificial neural network by unsupervised learning, reinforcement learning or stochastic learning.

Preferably, the simulation dosage model is stored on a storage device (in particular described in more detail above), preferably external to the apparatus. Preferably, the apparatus can access this external storage device and, in particular, process the (predetermined) plurality of measured values by accessing it.

Preferably, the non-volatile storage device is an external storage device, in particular a cloud-based storage device and/or an external server (including storage device), wherein the storage device is accessed in particular via the Internet (and/or via a public and/or private network, in particular at least in sections wired and/or wireless). An external server is in particular an external server, in particular a backend server, in relation to the apparatus.

The external server is, for example, a backend, in particular of a dosage apparatus manufacturer or a service provider, which is set up to manage measured values (in particular of a plurality of measuring devices and/or a plurality of apparatuses (in particular apparatuses according to the invention)). The functions of the backend or the external server can be carried out on (external) server farms. The (external) server can be a distributed system.

These external storage devices are preferably able to make the stored data and/or their evaluations available to the machine from the external storage device. The evaluation of measured values described here makes it possible to create forecasts for the operation of the apparatus. For example, a forecast that a certain component of the apparatus will fail in the near future can be derived from a certain course of certain measured values. In this way, the user can be proactively instructed to carry out certain maintenance or to replace a certain component.

It can also be concluded from certain measured values, such as pressure values, that the pump device is insufficiently vented. In this way, the evaluation device can simulate the experience of a machine operator, who can draw conclusions about other sources of error from the specific behavior of certain measured values based on this experience.

An evaluation device and, in particular, an AI could derive predictions from large amounts of data. For example, when a certain fault occurs, other measured values could also be taken into account or it could be checked whether they had already changed before the fault occurred. In this way, the AI can use its “experience” to provide indications of a future error in the event of certain changes in the measured values. In this case, the AI emulates the experience of the machine operator.

As mentioned above, the machine data from many similar machines could also be stored and evaluated. In this way, the evaluation device or the AI can learn whether and how the installation locations of the machines and their ambient conditions affect machine operation. Furthermore, the evaluation could also take into account different beverages.

As mentioned above, a virtual machine is preferably created (the simulation), which simulates the operation of the actual machine and can work with the real data obtained. In this case, the AI can contribute to the continuous improvement of the system.

In a further preferred method, the control device controls the pump device using at least one first physical parameter which is characteristic of ambient conditions at an operating location of the system and/or using at least one second physical parameter which is characteristic of a physical property of the beverage to be preserved.

Preferably, at least one of these physical parameters is determined and, on the basis of this parameter, an operating recipe is determined independently of the apparatus, by which the control device controls the pump device.

Preferably, this operating recipe is determined at least at a different location from the operating site. For example, it would be possible for said physical parameters to be determined at the operating location and for the corresponding operating recipes to be determined at another location, such as the manufacturing location of the system, on the basis of these parameters. For example, it would be possible for a plurality of sensors to be located at the operating site, for example in a customer's hall, which measure environmental conditions. This data can then be transferred to the manufacturer of the machine and preferably analyzed there.

In a further preferred method, operating conditions are simulated and/or created on the basis of the at least one physical parameter at the location other than the operating location, which are adapted to the ambient conditions at the operating location. For example, it is possible to use a climate chamber at the production site in which the ambient conditions at the operating location are simulated or daily profiles or entire long-term profiles are simulated. For example, a daily temperature can be measured at the operating location and this operating temperature can be simulated in a test environment.

Determining the operating recipe independently of the apparatus is understood in particular to mean that this determination is carried out independently of this system in terms of time and/or location, in particular at a different location. In particular, it is irrelevant for the determination of the operating recipe whether the system is currently in operation or not. In other words, the determination of the operating recipe in particular does not depend on a current state of the apparatus.

It is therefore proposed that corresponding operating recipes for operating the apparatus and/or the pump device are determined and, in particular, on-site conditions of the apparatus and, in particular, of the pump device are taken into account and/or conditions which are characteristic of the operation of the apparatus at its operating location, such as, in particular but not exclusively, climatic conditions at the operating location or, for example, liquid-specific conditions (e.g. the type of beverage to be preserved).

It is therefore preferable to propose a way of taking the aforementioned influences into account even before operation or commissioning. In this context, the term “before commissioning” means that an operating recipe obtained using this method is already taken into account during the manufacture or construction of the apparatus, i.e. is already transferred to the control unit, for example. The advantage is that at least a rough parameterization can be specified. A further advantage is that the apparatus can “start up” at the customer's premises at least with reduced performance/quality and then be fine-tuned, for example by the manufacturer's specialists. These specialists therefore no longer have to wait until all mechanical and electrical shortcomings have been rectified, but can arrive just in time.

In a further preferred method, the operating recipe contains at least one operating parameter, preferably a plurality of operating parameters. Operating parameters are understood to be parameters that are relevant to the preservation of the beverages or that are predetermined. Advantageously, these operating parameters are selected from a group of operating parameters which includes a flow rate of the preserving agent, a pressure of the preserving agent, a temperature of the preserving agent during injection, a flow rate of the beverage to be preserved, a temperature of the beverage to be preserved and the like.

### BRIEF DESCRIPTION OF THE DRAWINGS

Further advantages and embodiments are shown in the attached drawings. In the drawings:

FIG. 1 shows a schematic representation of an apparatus according to the invention;

FIG. 2 shows a diagram illustrating the data storage;

FIG. 3 shows a representation of collected data.

### DETAILED DESCRIPTION OF THE INVENTION

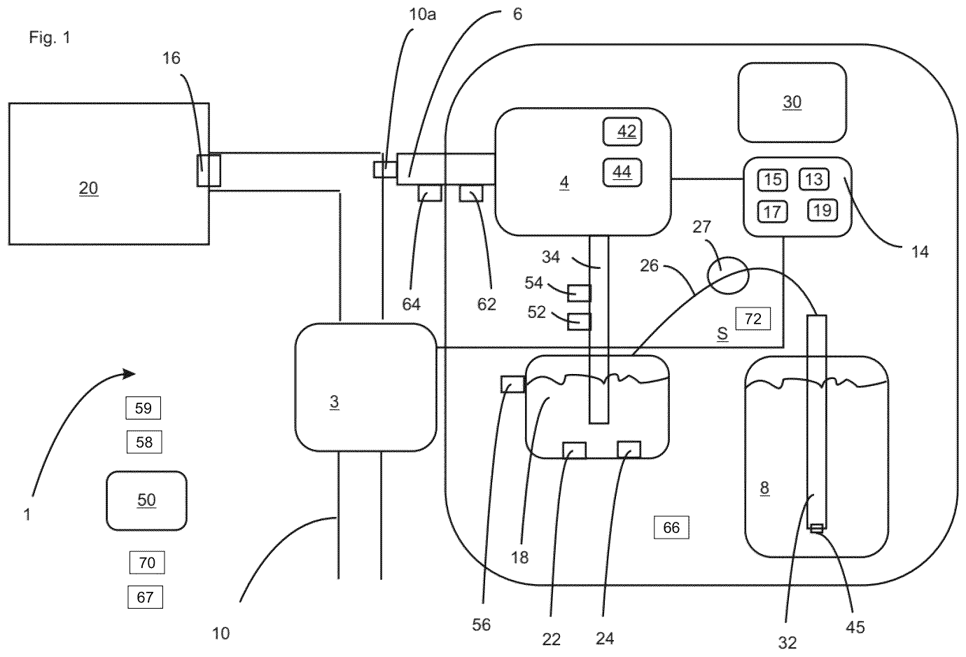

FIG. 1 shows a schematic representation of an apparatus 1 according to the invention. It should be noted that the embodiment shown here is exemplary, in particular with regard to the sensors or measuring device shown, and that other sensors or locations for the sensors may be provided depending on the embodiment.

In FIG. 1, the reference sign 10 indicates a liquid line and, in particular, a beverage line in which the liquid or beverage is conveyed to a container 20.

The reference sign 3 indicates a measuring device, such as in particular but not exclusively a flow sensor, which is suitable and intended for determining the flow rate of the beverage flowing through the liquid line 10.

The reference sign 4 identifies a pump device which is used to supply a preserving agent to the beverage via a supply line and, in particular, a pressure line 6 and a nozzle 10a. This pump device 4 is controlled by a control device 14. This nozzle 10a can preferably be tempered and, in particular, heated. Furthermore, a temperature measuring device (not shown) can be provided to determine the temperature of the nozzle.

The measuring device 3 transmits a value to the control device 14 which is characteristic of the flow rate of the liquid flowing through the liquid line 10 and the control device 14 controls the pump device 4 taking this value into account.

The reference sign 8 identifies a first receiving container which serves to receive the liquid preserving agent. This receiving container is preferably interchangeable and is preferably designed without a sensor device. The reference sign 32 identifies a removal device which is suitable and intended for removing the liquid from the receiving container 8. This removal device is preferably designed as a hollow lance which sucks the preserving agent out of the receiving container.

The reference sign 45 indicates a sensor and in particular a pressure sensor, which in an advantageous embodiment is arranged at a lower end of the removal device.

Via a connecting line 26 (shown only schematically), preserving agent removed from the receiving container 8 is supplied (preferably using a pump device 27) to a further receiving container 18, which is designed here as a buffer container.

The pump device 4 can suck the preserving agent out of the buffer container 18 via a connecting line 34. The buffer container 18 makes it possible to continue operating the apparatus 1 even during the periods in which the receiving container 8 is replaced.

In a preferred embodiment, at least one first pressure sensor 22 and preferably two pressure sensors 22, 24 are arranged at the bottom of the buffer container. By this pressure sensor 22, a pressure of the liquid inside the buffer container 18 can be determined and thus the fill level of the liquid in the buffer container can be inferred.

In an alternative embodiment or additionally, a pressure sensor or preferably two pressure sensors 52, 54 can also be provided on the connecting line. The measured values output by these pressure sensors 52, 54 can also (additionally or alternatively) be used to infer a flow rate of the liquid through the connecting line 34 and thus a delivery rate.

The reference sign 56 identifies a fill level sensor that determines a fill level of the preserving agent within the receiving container 18. The data measured by this fill level sensor is used in particular to check the values output by the pressure sensors.

The reference signs 62 and 64 indicate further pressure sensors which are arranged in the pressure line 6 in addition to or as an alternative to the sensors described above. In this way, too, a delivery rate of the preserving agent supplied to the beverage line 10 can be determined.

In addition, these pressure sensors can also be used to check whether the preserving agent is being supplied to the liquid line at a sufficient pressure or within predetermined limits.

The individual measured values of the sensors are preferably supplied to the control device 14, which also controls and in particular regulates the pump device on the basis of these measured values.

Preferably, the pump device also has at least one sensor device 42 and preferably several sensor devices 42, 44. These may be position sensors, for example, which determine the position of specific pump elements. In addition, they may also be current or voltage sensors which determine characteristic values for the operation of the pump device or the like.

The values of these sensor devices are also preferably supplied to the control device 14 for controlling and/or regulating the pump device 4.

The reference sign 30 indicates a display and/or operating device for operating the apparatus. This display and/or operating device 30 is preferably suitable and intended for outputting information which is significant for the operation of the apparatus, such as measured pressures or the like. In addition, user inputs can preferably be made via this display and/or operating device 30.

A fill level display and/or pressure display and/or flow rate display can be visualized directly on a touch panel (of the display and/or operating device 30). This makes it possible to announce the bottle changes to the operator in good time.

The reference sign 15 identifies a storage device that is suitable and intended for storing measured values. This storage device can be integrated into the control device.

The reference sign 17 indicates a timer device which predetermine a time value with which different measured values are stored in the storage device 15.

The reference sign 19 indicates an interface by which the stored data can be read out, for example by means of a USB stick.

The reference sign 13 indicates a transmission device by which stored data can be sent to another storage device 50, such as a cloud storage.

The reference sign 72 identifies a position detection device which serves to detect a (geographical) position of the apparatus or to contribute to a detection of the apparatus. This position detection device is preferably permanently connected to the apparatus and/or the pump device. Preferably, the position of the apparatus 1 can also be queried remotely.

The reference sign 58 identifies a dosage model generation device which is suitable and intended for generating a dosage model of the apparatus on the basis of predetermined values, in particular the measured values of the apparatus or on the basis of already existing data.

The reference sign 59 identifies an assignment device which assigns business data to the apparatus 1, such as data which is characteristic of contract processing with regard to this apparatus.

The reference symbol 70 identifies a further (external) control device which is used to control the apparatus. This further control device allows remote control of the apparatus. In particular, this further control device can control the apparatus remotely.

Preferably, it is possible for both of the aforementioned control devices to control the apparatus. However, it is also possible that one of the two control devices, and in particular the further control device 70, is given priority and can take over control of the apparatus at least with regard to some processes. For example, it is preferably possible for the further control device (for example in emergency situations) to switch off the apparatus 1.

Preferably, the apparatus has a display device which enables measured values, operating states or the like to be displayed at a location remote from the apparatus, for example a location of the manufacturer of the apparatus 1. For example, it is possible to output such data via an operator's cell phone. Preferably, the display device is a mobile display device.

The reference sign 66 identifies a further measuring device which is suitable and intended for recording ambient data. In particular, this environmental data can be a temperature, a pressure or a humidity at the installation site of the apparatus 1. This environmental data can also be used by the control device 14 or the control device 70 to control the apparatus 1.

The reference symbol 67 identifies a further detection device that detects the operating behavior of one or more operators of the apparatus 1. For example, control commands entered via an input device can be recorded. It is also possible, for example, to record when or how often the preservative was changed.

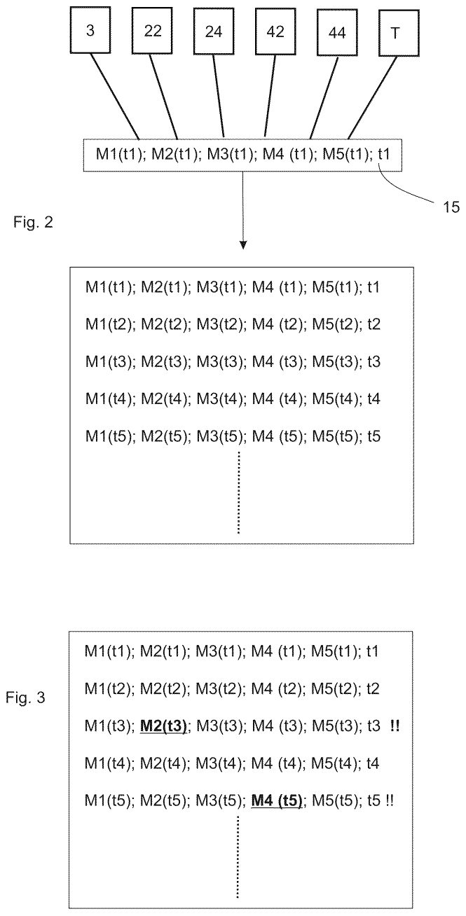

FIG. 2 illustrates the procedure for storing data. Five measuring devices 3, 22, 24, 42 and 42 are shown here as examples, which output measured values that are characteristic of different properties of the apparatus. The reference symbol T indicates a timer. This can trigger the measured value acquisition and/or add a time value to the measured value acquisition.

An n-tuple, in this case a 6-tuple of five measured values M1(t1), M2(t1), M3(t1), M4(t1) and M5(t1) measured at a specific time t1 is stored in the storage device. Furthermore, the time value t1 is recorded.

Preferably, the measured values M1-M5 are assigned to the individual measuring devices mentioned above.

This saving is repeated—preferably cyclically. In this way, a plurality of tuples of values are recorded at different times. These values are stored in the storage device 15.

FIG. 3 shows a compilation of a plurality of measured values. Error states are also recorded, which are schematically marked here by two exclamation marks. At the same time, the measuring device that supplied the faulty measured value is identified, namely at time t3 the measuring device 22, which supplied the measured value M2 and at time T5 the measuring device 42, which supplied the measured value M4.

This data can be used to obtain information about the system, for example about the condition of the preserving agent or about technical components of the apparatus. If, for example, the measuring devices 42 and 44 frequently produce incorrect measured values, this could be an indication that components of the pump device 4, such as valves, are worn and need to be replaced in the near future.

If the measuring device 3 delivers strongly deviating measured values, this could indicate a fault in the higher-level beverage filling system.

The applicant reserves the right to claim all features disclosed in the application documents as being essential to the invention, provided that they are new, either individually or in combination, compared to the prior art. It should also be noted that the individual figures also describe features which may be advantageous in themselves. The person skilled in the art will immediately recognize that a certain feature described in a figure can also be advantageous without the adoption of further features from this figure. Furthermore, the skilled person recognizes that advantages can also result from a combination of several features shown in individual figures or in different figures.

1-15. (canceled)

16. An apparatus for preserving beverages, having a measuring device which is configured for determining a flow rate of a liquid flowing through a beverage line, and having a pump device which is configured to convey a preserving agent, in particular dialkyl dicarbonates, into the beverage line, and having at least two further measuring devices which are configured to measure at least two further characteristic measured values for operating the apparatus, wherein the apparatus having a control device configured for controlling the pump device,
wherein
the apparatus has a storage device which is configured to enable repeated storage of at least the further characteristic measured values and the control device is configured for controlling the pump device as a function of at least one of the stored measured values.

17. The apparatus according to claim 16,
wherein
the apparatus has at least three, four or five further measuring devices, which each are configured to determine at least one measured value (M2, M3, M4, M5) characteristic of the operation of the apparatus.

18. The apparatus according to claim 16,
wherein
the control device is configured for controlling the apparatus by remote data transmission.

19. The apparatus according to claim 16,
wherein
the apparatus has a position detection device which is configured for detecting a position of the apparatus.

20. The apparatus according to claim 16,
wherein
the control device is configured for controlling the apparatus as a function of a detected position of the apparatus.

21. The apparatus according to claim 16,
wherein
the apparatus is configured for detecting and/or recording alarm and/or error states.

22. The apparatus according to claim 16,
wherein
the apparatus and in particular the pump device is configured for recording a plurality of machine and/or consumption data and for storing said data.

23. The apparatus according to claim 16
wherein
the apparatus has at least one detection device configured for detecting ambient data.

24. The apparatus according to claim 16,
wherein
the apparatus has a detection device configured for detecting the operating behavior of an operator.

25. The apparatus according to claim 16,
wherein
the apparatus has an evaluation device configured for evaluating the measured values.

26. The apparatus according to claim 16,
wherein
the apparatus has a model generation device which is configured to generate a machine model characteristic of the apparatus on a basis of a plurality of measured values.

27. The apparatus according to claim 16,
wherein
the apparatus has an artificial intelligence by which the apparatus is controlled.

28. A method for preserving beverages, wherein a measuring device determines a flow rate of a liquid flowing through a beverage line, and a pump device conveys a preserving agent, in particular dialkyl dicarbonates, into the beverage line, and wherein at least two further measuring devices determine at least two further characteristic measured values for the operation of the apparatus, and wherein a control device controls the pump device,
wherein
the apparatus has a storage device which repeatedly stores at least the further characteristic measured values and the control device controls the pump device as a function of at least one of the stored measured values.

29. The method according to claim 28,
wherein
alarm and/or error states are recorded and, data and/or measured values characteristic of these alarm and error states are recorded.

30. The method according to claim 28,
wherein
the apparatus is at least temporarily remote-controlled and/or the control device controls the pump device using at least one first physical parameter which is characteristic of ambient conditions at an operating location of the system and/or using at least one second physical parameter which is characteristic of a physical property of the beverage to be preserved.

31. The apparatus according to claim 17,
wherein
the control device is configured for controlling the apparatus by remote data transmission.

32. The apparatus according to claim 17,
wherein
the apparatus has a position detection device which is configured for detecting a position of the apparatus.

33. The apparatus according to claim 32,
wherein the control device is configured for controlling the apparatus as a function of a detected position of the apparatus.

34. The apparatus according to claim 17,
wherein
the apparatus is configured for detecting and/or recording alarm and/or error states.

35. The apparatus according to claim 17,
wherein
the apparatus and in particular the pump device is configured for recording a plurality of machine and/or consumption data and for storing said data.
